(19) United States
(12) Patent Application Publication
(10) Pub. No.: US 2012/0306896 A1
(43) Pub. Date: Dec. 6, 2012

(54) DISPLAY DEVICE OF A MOTOR VEHICLE

(75) Inventors: Lutz Krauss, Karlsruhe (DE); Timo Seehaus, Steinheim (DE); Rolf Hartmann, Stuttgart (DE); Albrecht Böttiger, Grafenau-Doffingen (DE)

(73) Assignee: Dr. Ing. h.c. F. Porsche Aktiengesellschaft, Stuttgart (DE)

(21) Appl. No.: 13/520,387

(22) PCT Filed: Dec. 18, 2010
(86) PCT No.: PCT/EP2010/007776

§ 371 Date: Jul. 3, 2012

(30) Foreign Application Priority Data
Feb. 25, 2010 (DE) 10 2010 010 442.6

(51) Int. Cl. G06T 1/00

(52) U.S. Cl. 345/501

(57) ABSTRACT

A display device of a motor vehicle, on which a map corresponding to a current vehicle position can be displayed in a display mode under the control of a navigation device, wherein a racetrack on which the motor vehicle is operated can be displayed on the display device in a further display mode.

### CROSS-REFERENCE TO RELATED APPLICATIONS

This is a U.S. National Phase Patent Application of PCT International Patent Application Number PCT/EP2010/007776, filed Dec. 18, 2010, which claims priority benefit of DE 10 2010 010 442.6, filed Feb. 25, 2010, each of which is incorporated herein by reference in its entirety.

### FIELD OF THE INVENTION

The invention relates to a display device of a motor vehicle, on which a map corresponding to a current vehicle position can be displayed in a display mode under the control of a navigation device.

### BACKGROUND OF THE INVENTION

In practice, display devices of a motor vehicle, on which a map corresponding to a current vehicle position and the position of the motor vehicle on this map can be displayed under the control of a navigation device, are already known.

### SUMMARY OF THE INVENTION

Taking this as a starting point, the present invention provides a novel display device of a motor vehicle with an extended functionality.

According to a first aspect of the invention, a display device of a motor vehicle, on which a map corresponding to a current vehicle position can be displayed in a display mode under the control of a navigation device, wherein a racetrack on which the motor vehicle is operated can be displayed on said display device in a further display mode. According to the above, the display device, according to aspects of the invention, displays, in a further display mode, a racetrack on which the motor vehicle is operated. According to the first aspect of the present invention here, it is possible for the first time that when a motor vehicle is operated on a racetrack the respective racetrack is displayed in a defined display mode of the display device. This display mode is preferably activated by means of a timing device by means of which lap times and/or lap section times can be acquired, wherein lap times and/or lap section times can then also preferably be displayed on the display device in addition to the racetrack.

According to a second aspect of the invention, the display device of a motor vehicle, on which a map corresponding to a current vehicle position can be displayed in a display mode under the control of a navigation device, wherein in a further display mode a quansi-spatial or perspective image of the surroundings, which is generated from a plurality of camera images, can be displayed on said display device. According to the above, the display device according to aspects of the invention displays, in a further display mode, a quasi-spatial or perspective image of the surroundings of the motor vehicle, which is generated from a plurality of camera images. According to the second aspect of the present invention here, on the display device it is possible to display, in a defined display mode, a quasi-spatial image of the surroundings which is generated or made up from images from a plurality of cameras which are installed in or on the motor vehicle. This image can either be an image of the surroundings in front of the motor vehicle or an image of the surroundings behind the motor vehicle.

### BRIEF DESCRIPTION OF THE DRAWINGS

Exemplary embodiments of the invention are explained in more detail with reference to the drawing without being restricted thereto. In said drawing:

FIG. 1 is a schematic illustration of an inventive display device of a motor vehicle in a first state together with a timing device;

FIG. 2 is a schematic illustration of an inventive display device of a motor vehicle in a second state; and

FIG. 3 is a schematic illustration of an inventive display device of a motor vehicle in a third state.

### DETAILED DESCRIPTION OF EXEMPLARY EMBODIMENTS OF THE INVENTION

The present invention here relates to a display device of a motor vehicle.

The present invention here relates to display device of a motor vehicle. On such a display device, a map corresponding to a current vehicle position can be displayed in a display mode under the control of a navigation device, and the position of the motor vehicle can likewise be displayed on this map. Then, when a route is activated in the navigation device, the route can also be displayed on the map.

In order to increase the functionality of such a display device, according to a first aspect of the invention there is provision that a racetrack on which the motor vehicle is operated can be displayed on the display device in a further display mode.

In this context, the current position of the motor vehicle on the racetrack is preferably also displayed under the control of the navigation device. The racetrack is preferably displayed in a quasi-spatial or perspective fashion.

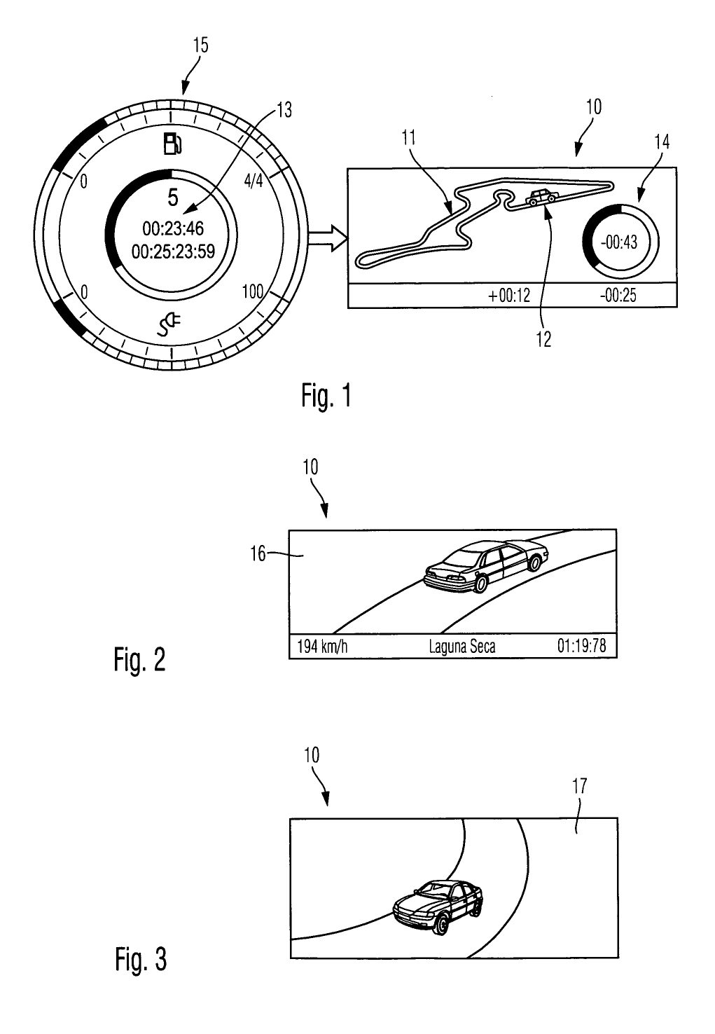

For example, FIG. 1 shows a display device 10 of a motor vehicle, by which display device 10 a racetrack 11, on which the motor vehicle is operated, is displayed in a quasi-spatial or perspective fashion in such a display mode, and the position of the motor vehicle 12 is likewise displayed on the racetrack 11.

The further display mode in which the display device 10 displays the racetrack 11 is preferably activated at the driver's end by means of a timing device 13 which serves to acquire lap times and/or lap section times of the motor vehicle which is operated on the racetrack.

Such a timing device 13 is also referred to as a sport chrono, wherein according to one advantageous development of the invention, in the display mode of the display device 10 in which the display device 10 is used to display the racetrack 11, data of the timing device 13, for example a lap section time according to FIG. 1, are also displayed on the display device 10 in a defined display area 14.

The timing device 13 is preferably a component of a display device 15 of a combination instrument. Here, according to FIG. 1 the display device 15 of the combination instrument is also used to display a filling level of a fuel tank and a charge state of an electric energy store. The activation, at the driver's end, of the timing device 13 and of the display mode in which the display device 10 displays the racetrack 11 is preferably carried out by means of a steering-wheel-side operator control element.

According to a second aspect of the invention, the display device 10 according to aspects of the invention can display, in a further display mode, a quasi-spatial image of the surroundings of the motor vehicle, which image is generated or made up from a plurality of camera images. FIG. 2 therefore shows the display device 10 with an image of the surroundings 16 in front of the motor vehicle. FIG. 3 shows the display device 10 with an image of the surroundings 17 behind a motor vehicle.

The quasi-spatial or perspective image, specifically the quasi-spatial or perspective image of the surroundings 16 or 17, which is displayed on the display device 10 according to the second aspect of the invention, is generated by means of a control device (not shown) which is assigned to the display device 10 and which generates the quasi-spatial or perspective image of the surroundings from images of at least two cameras.

The control device preferably uses images of three cameras to generate the quasi-spatial or perspective image of the surroundings. These cameras are, of course, installed at different positions in the motor vehicle or on the motor vehicle.

It is therefore possible for a first camera to be installed in the region of a license plate position of the motor vehicle and further cameras to be installed in the region of rear view mirror positions of the motor vehicle.

The two aspects according to aspects of the invention can also be used in combination with one another on a display device 10, wherein said display device is then used to display a map in a first display mode, to display a racetrack and to display data of a timing device in a second display mode, and to display an image of the surroundings of the motor vehicle in a third display mode.

1.-9. (canceled)

10. A display device of a motor vehicle, wherein the display device is configured to display a map corresponding to a current vehicle position on the display device in a display mode under the control of a navigation device, wherein the display device is also configured to display a racetrack on which the motor vehicle is operated on said display device in a further display mode.

11. The display device as claimed in claim 10, wherein the display device is configured to display the racetrack in a quasi-spatial view or a perspective view.

12. The display device as claimed in claim 10, wherein said display device displays the current position of the motor vehicle on the racetrack under the control of the navigation device.

13. The display device as claimed in claim 10, wherein the racetrack on which the motor vehicle is operated is displayed by said display device when a timing device is actuated by a driver of the vehicle.

14. The display device as claimed in claim 13, wherein, the display device displays the racetrack and at least one of lap times and lap section times in a defined display area, under the control of the timing device.

15. A display device of a motor vehicle that is configured to display a map corresponding to a current vehicle position in a display mode under the control of a navigation device, wherein the display device is configured to display, in a further display mode, a quasi-spatial or perspective image of surroundings of the motor vehicle, which is generated from a plurality of camera images.

16. The display device as claimed in claim 15, wherein said display device displays a quasi-spatial or perspective image of the surroundings of the motor vehicle, which image is generated by a control device assigned to said display device, from images of at least two cameras which capture the surroundings of the motor vehicle.

17. The display device as claimed in claim 16, wherein said display device displays a quasi-spatial or perspective image of the surroundings of the motor vehicle, which image is generated by the control device which is assigned to said display device, from images of three cameras which capture the surroundings of the motor vehicle.

18. The display device as claimed in claim 15, wherein said display device displays a quasi-spatial or perspective image of the surroundings in front of the motor vehicle or a quasi-spatial or perspective image of the surroundings behind the motor vehicle.
